(19) United States
(12) Patent Application Publication
(10) Pub. No.: US 2006/0036446 A1
(43) Pub. Date: Feb. 16, 2006

(54) Integrated playback apparatus and internal operating method thereof

(76) Inventor: Tingkun Yeh, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,314

(22) Filed: Aug. 16, 2005

Related U.S. Application Data
(60) Provisional application No. 60/601,613, filed on Aug. 16, 2004.

(51) Int. Cl. G10L 21/00

(52) U.S. Cl. 704/500

(57) ABSTRACT

The present invention provides a system-on-chip for an optical disc playback apparatus and operating method thereof. The system-on-chip includes a processing unit for issuing providing a request data command and a requested data transmission data command, a servo module, and a MPEG module. The servo module receives the request data command, and reads a requested data requested by the data request command from a storage medium into a common buffer of an address of a memory module of the playback apparatus. Moreover, the MPEG module is configured to receive the read request data transmission command so as to fetch the requested data from the memory module by means of an initial address indicating where the requested data is stored in the common buffer and the size of the requested data before further decoding for playback.

### CROSS REFERENCE TO RELATED APPLICATIONS

This application claims the benefit of U.S. Provisional Application No. 60/601,313, filed on Aug. 16, 2004, which is herein incorporated by reference for all intents and purposes.

### BACKGROUND OF THE INVENTION

1. Field of the Invention

The present invention generally relates to a playback apparatus and internal operating method thereof, and more particularly to an integrated playback apparatus and internal operating method thereof.

2. Description of the Prior Art

Conventionally, a playback process of playback apparatus involves two major steps: reading data from DVD, and decoding the data. Reading data is usually controlled by a servo chip. After the data is read out, decoding chip is used to process the read data and generate the audio and video outputs.

Please refer to FIG. 1, which shows a conventional DVD playback architecture 100 which comprises a well-known ATA (AT Attachment) bus 110. In this architecture 100, a DVD Servo chip 120 connected to the ATA bus 110 served as the controller role of a DVD reader. When the DVD Servo chip 120 receives the ATAPI (ATA Programmable Interface) commands, transmits the data on the DVD disk. A local Servo Chip RAM 125 connected directly to the DVD Servo chip 120 is taken as a data buffer of the DVD. In this regard, a MPEG (Motion Picture Experts Group) A/V Decoder chip 130 is also connected to the ATA bus 110. Also as a data buffer, a MPEG A/V RAM 135 is connected to the MPEG AN Decoder chip 130.

In the architecture 100, a chuck of data, for example, 2 kilo bytes, is required by the decoding process of the MPEG A/V Decoder chip 130. At first, a request ATAPI command is issued to the DVD Servo chip 120 via the ATA bus 110. Therefore, the DVD reader is controlled by the DVD Servo chip 120 and the requested chuck of data is read into the Servo Chip RAM 125. Secondly, the requested chuck of data is read by the MPEG AN Decoder chip 130 via the ATA bus 110. During the transmission period, the chuck of data has to store again in the MPEG AN RAM 135. At last, the MPEG A/V Decoder chip 130 processes the chuck of data and generates audio and video outputs.

In most cases, since the ATA bus 110 is shared by other devices (not shown in the FIG. 1), the transmission of the chuck of data may be delayed due to resource conflict. Besides, the chuck of data is stored concurrently at two different places, the Servo Chip RAM 125 and the MPEG AN RAM 135. It wastes space and time to duplicate the chuck of data. Furthermore, since the transmission rates of the ATA bus 110 is different to the rates of Servo Chip RAM 125 and the MPEG AN RAM 135, additional FIFO (first-in, first-out) circuits connected to the RAM 125 and 135 may be used in implementations.

If the size of the Servo Chip RAM 125 is as large as the required chuck of data, the DVD Servo chip 120 has to wait for completing duplicated data before reading next chuck of data. It means that the duplicated data and the read data can not be processed at the same time. In other words, the whole process can not be pipelined. In the case of reading error or the ATA bus 110 busy, the DVD playback process may be stand for a while.

In this architecture 100, it needs at least two Chips 120 and 130, which both have internal ATA interfaces. Moreover, two local buffer RAM 125 and 135 are required to attach to these two Chips 120 and 130. Besides, the bandwidth of the ATA bus 110 is shared by these two chips 120 and 130. In a continual playback circumstance, the ATA bus 110 has to carries all data on the DVD disc, which is a tremendous quantity. After all, the integration issues of the architecture 100 are also major considerations of implementations. To decrease the number of components is to decrease the integration efforts and risks. Therefore, the competition is enhanced in this very competitive market.

In summarized, it is desired to have an integrated DVD playback apparatus to benefit the competences of the DVD industry.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention discloses a data transmission method in a playback apparatus. The method comprises providing a SOC (system-on-chip), which further comprising a processing unit, a servo module, and a MPEG module. At first, a request data command is sent to said servo module by the processing unit. Next, a requested data on a storage medium, loaded in the playback apparatus, is stored into a storage address of a common buffer in a memory module by the servo module according to said request data command. In following step, a requested data transmission command with the storage address and a requested data size is sent to the MPEG module by the processing unit. At last, the requested data is acquired and decoded by the MPEG module according to said requested data transmission command. The present invention further provides a system-on-chip of a playback apparatus. The system-on-chip comprises a processing unit for sending a request data command and a requested data transmission command, a servo module for receiving said request data command, reading a requested data from a storage medium loaded in said playback apparatus, and storing said requested data to a common buffer in a memory module, and a MPEG module for receiving said requested data transmission command and decoding said requested data from said common buffer in said memory module.

Summarized, the integrated DVD playback apparatus provided by the present invention could reduce the number of components and the risk of integration. Therefore the apparatus could increase the competence in this crowded market.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates a conventional DVD playback architecture which comprises a well-known ATA bus;

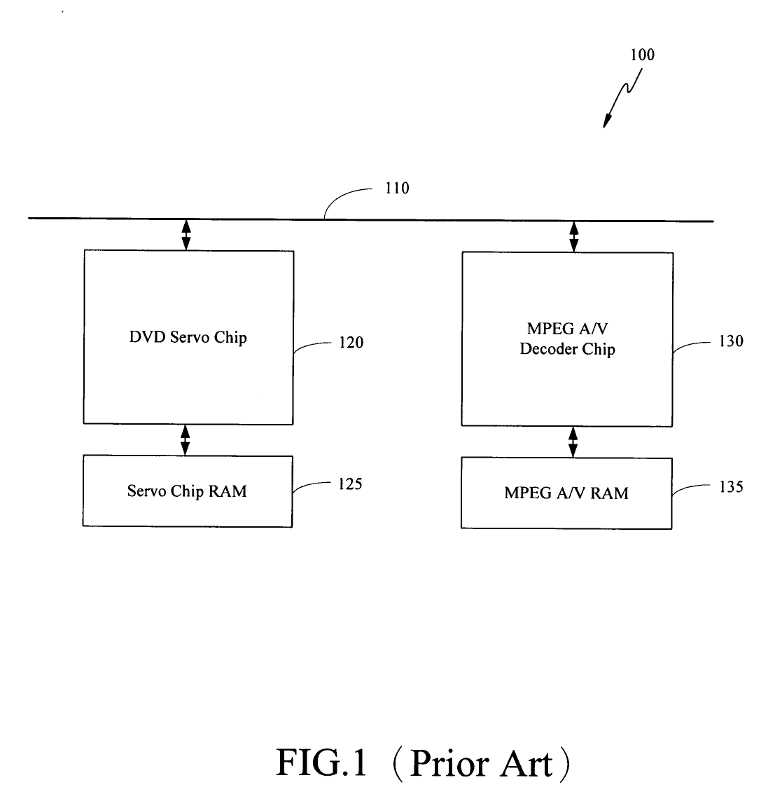

FIG. 2 is a block diagram shows a playback apparatus of an embodiment in accordance with the present invention; and

FIG. 3 is an internal data transmission flowchart diagram of the apparatus shown in the FIG. 2.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

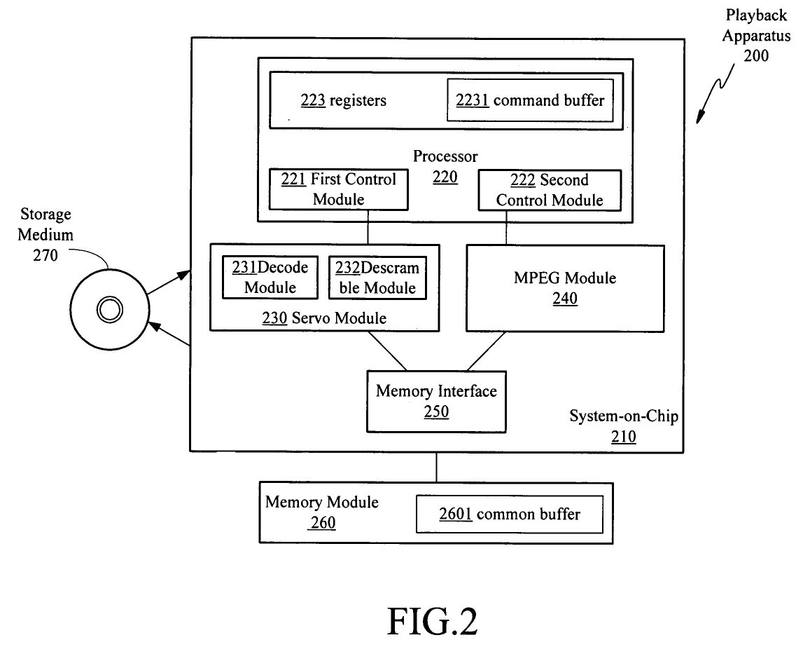

Please refer to FIG. 2, which is a block diagram shows a playback apparatus 200 of an embodiment in accordance with the present invention. The apparatus 200 comprises a SOC (system-on-chip) 210, a memory module 260 connecting to the SOC, and a storage medium 270. In this embodiment, the storage medium 270 is a DVD or VCD disc. However, the present invention does not restrict that the types of this optical disc is read-only, write-once, or erasable. In a preferred embodiment, the memory module 260 could be DRAM (dynamic random access memory).

The SOC 210 further comprises a processing unit 220, a servo module 230 for serving the storage medium 270, a MPEG module 240, and a memory interface 250. The processing unit 220 may be general central processing unit including a register 223 for executing operating system and applications. In this regard, the processing unit 220 could comprise a first control module 221 and a second control module 222 for transmitting control commands to the servo module 230 and the MPEG module 240, respectively. The servo module 230 is followed commands by the first control module 221, to read the request data from the storage medium 270 and store the requested data to a common buffer 2601 of the memory module 260 via the memory interface 250. An initial address and size of the common buffer 2601 are indicated by a storage address and the request data size. Moreover, the servo module 230 transmits the commands including the storage address and a requested data size to the first control module 221. Then the first control module 221 sends a notice command for storing the requested data into a command buffer 2231 of the register 223. According to the indication of the notice command including the storage address and the requested data size, the second control module 222 sends the requested data transmission command (including the storage address and the requested data size) to MPEG module 240. The MPEG module 240 reads the requested data stored in the common buffer 2601 of the memory module 260) by the storage address and the requested data size. After reading the requested data, processing the decoding step by MPEG module.

In this embodiment, the second control module 222 of the processing unit 220 could send a requested data transmission command to the MPEG module 240 for notifying that the requested data is stored in a storage address of the common buffer 2601 in the memory module 260. Accordingly, the MPEG module 240 could acquire the requested data from the storage address of the common buffer 2601 and precede standard MPEG decoding procedure. Moreover, since the requested data on the storage medium is encoded and scrambled, therefore the servo module 230 further comprises a decode module 231 and a de-scramble module 232 for decoding and de-scrambling the requested data before storing. Furthermore, the processing unit sends next request data command to the servo module while the servo module stores the requested data in the storage address of the common buffer.

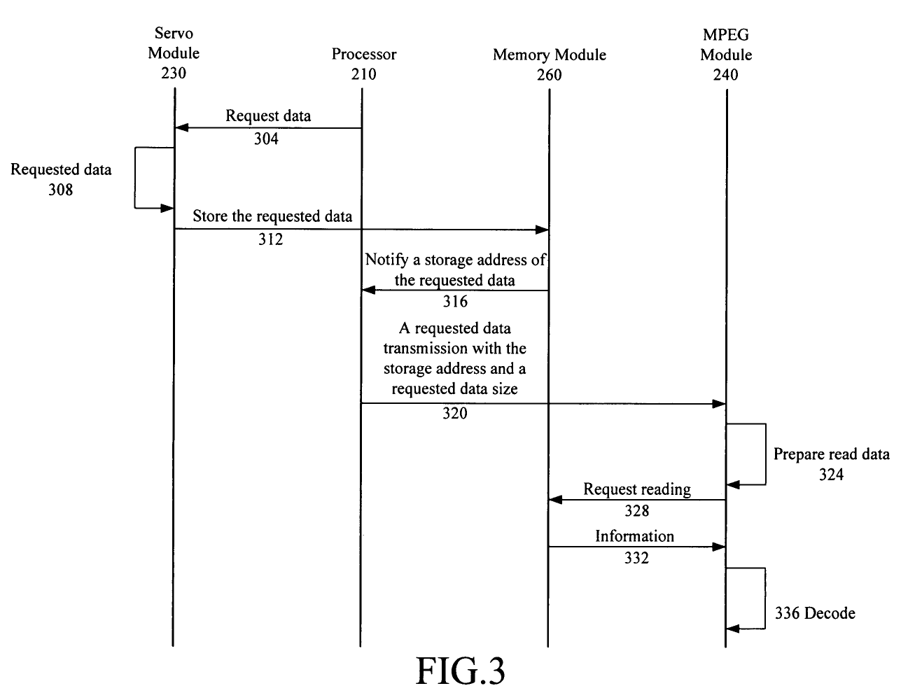

Please refer to FIG. 3, which is an internal data transmission flowchart diagram of the apparatus 200 shown in the FIG. 2. At first, in step 304, the processing unit 220 or the first control module 221 provides a request data command to the servo module 230. Next, according to the received request data command, the servo module 230 read the requested data from the storage medium 270 in step 308. Consequently, the requested data is stored to a storage address of the common buffer 2601 in the memory module 260 by the servo module 230 in step 312. As mentioned above, a decode procedure and/or a descramble procedure may be performed, between step 308 and 312, to decode and/or descramble the requested data before storing. After storing, the servo module 230 would notify the processing unit 220 about the storage address and a requested data size of the common buffer 2601 in the memory module 260 in step 316.

After receiving the notification, the processing unit 220 or the second control module 222 would provide a requested data transmission command to the MPEG module 240 in step 320. Next, in step 324, the MPEG module 240 would prepare to acquire the requested data stored in the storage address via the memory interface 250. In the following two steps 328 and 332, the requested data is acquired by the MPEG module 240. At last, the requested data is decoded by the MPEG module 240 in step 336.

As shown above, compared with traditional transmission methods of a request data, the invention provides an integrated playback apparatus by internal command operation in a single process unit of system-on-chip for solving lack of bandwidth and saving redundant components. Moreover, the invention can save complicated steps and time. Servo module 230 and MPEG module 240 access into the common buffer 2601 indicated by a storage address and a requested data size. MPEG module 240 indicates the requested data read from the common buffer 2601 for decoding. Compared with the prior art, the requested data must be stored in the common buffer 2601 and reading the requested data from the common buffer 2601 for decoding. Furthermore, it enhances the playback efficiency due to simplifying operation steps.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A data transmission method in an integrated playback apparatus, wherein the integrated playback apparatus comprises a system-on chip (SOC), and said SOC comprises a processing unit, a servo module, and a MPEG module, the method comprising:
providing, by said processing unit, a request data command to said servo module;
reading, by said servo module, a requested data from a storage medium loaded in said playback apparatus according to said request data command;
storing, by said servo module, said requested data in a common buffer of a memory module;
providing, by said processing unit, a requested data transmission command to said MPEG module, wherein said requested data transmission command comprising a storage address and a requested data size of said requested data stored in said common buffer of said memory module; and
reading, by said MPEG module, said requested data from said memory module for decoding according to said requested data transmission command.

2. The method of claim 1, wherein said processing unit further comprises a first control module and a second control module for providing said request data command and said requested data transmission command, respectively.

3. The method of claim 2, wherein said first control module stores a notice command to a command buffer for notifying said second control module to provide said requested data transmission command.

4. The method of claim 3, wherein said command buffer is located in a register of said processing unit.

5. The method of claim 3, wherein said notice command further comprises said storage address and said requested data size.

6. The method of claim 1, wherein said storage address indicates said requested data stored in an initial address of said common buffer.

7. The method of claim 1, wherein said servo module stores said requested data to said storage address in said common buffer of memory module via a memory interface.

8. The method of claim 1, wherein said processing unit sends next request data command to said servo module while said servo module stores said requested data in said storage address of said common buffer.

9. The method of claim 1, further comprising:
decoding, by said servo module, said request data before said storing.

10. The method of claim 9, further comprising:
descrambling, by said servo module, said request data before said storing.

11. A system-on-chip in a playback apparatus, comprising:
a processing unit for providing a requested data command and a requested data transmission command;
a servo module for receiving said request data command to read a request data from a storage medium loaded in said playback apparatus, and storing said requested data to a common buffer in a memory module, wherein said requested data transmission command comprises said requested data stored in a storage address and a requested data size of said common buffer; and
a MPEG module for receiving said requested data transmission command and decoding said requested data in said common buffer, wherein said requested data transmission command comprises a storage address and a requested data size.

12. A system-on-chip of claim 11, wherein said processing unit further comprising:
a first control module for providing said request data command; and
a second control module for providing said requested data transmission command.

13. A system-on-chip of claim 12, wherein said first control module stores a notice command to a command buffer for notifying said second control module to provide said requested data transmission command.

14. A system-on-chip of claim 13, wherein said command buffer located in a register of said processing unit.

15. A system-on-chip of claim 13, wherein said notice command further comprises said storage address and said requested data size.

16. A system-on-chip of claim 11, wherein said storage address indicates said request data stored in an initial address of said common buffer.

17. A system-on-chip of claim 11, wherein said servo module stores said request data to said storage address in said memory module via a memory interface.

18. A system-on-chip of claim 11, wherein said servo module further comprising a decode module for decoding said requested data.

19. A system-on-chip of claim 18, wherein said servo module further comprising a descramble module for descrambling said requested data.

20. A system-on-chip in a playback apparatus, comprising:
a processing unit for performing a first control module and a second control module, wherein said first control module provides a request data command and a notice command and said second control module receives the notice command for providing a requested data transmission command, said notice command is stored to a common buffer in a memory module;
a servo module for receiving said request data command to read a requested data from a storage medium loaded in said playback apparatus, and storing said requested data to a common buffer in a memory module; and
a MPEG module for receiving said requested data transmission command and decoding said requested data in said common buffer, wherein said requested data transmission command comprises said request data stored in a storage parameter of said common buffer.
